(19) United States
(12) Patent Application Publication
(10) Pub. No.: US 2014/0158217 A1
(43) Pub. Date: Jun. 12, 2014

(54) BACKWASH FITTING

(71) Applicant: ENVIRO WATER SOLUTIONS, INC., Deland, FL (US)

(72) Inventors: Ronald E. Stanley, New Smyrna, FL (US); Richard E. Stanley, New Smyrna, FL (US); Chad C. Galloway, New Smyrna, FL (US)

(73) Assignee: ENVIRO WATER SOLUTIONS, INC., Deland, FL (US)

(21) Appl. No.: 13/803,974

(22) Filed: Mar. 14, 2013

Related U.S. Application Data
(63) Continuation-in-part of application No. 29/439,325, filed on Dec. 10, 2012.

(51) Int. Cl. B01D 35/16; F16L 21/00

(52) U.S. Cl. CPC B01D 35/16; F16L 21/002
USPC 137/15.08; 285/351

(57) ABSTRACT

A fitting for connecting a hose to ports of a water filter bypass valve, the hose having an inner diameter less than that of the ports. The fitting includes a unitary base member, a second end connector, and first and second washers. The base member includes a first end connector securable to either of the ports, a neck having a truncated cone shaped inner wall, and a second end having a first outer diameter with a disk shaped flange extending outwardly to a second outer diameter greater than the first outer diameter. The second end connector has a radially inwardly extending flange disposed around the base member second end with and inner diameter greater than the first outer diameter and less than the second outer diameter of the base member second end. The first and second washers are in the first and second end connectors, respectively.

### CROSS-REFERENCE TO RELATED APPLICATIONS

This is a continuation-in-part application of U.S. Ser. No. 29/439,325, filed Dec. 13, 2012 entitled “Backwash Fitting”.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to a pipe fitting, and more particularly to a pipe fitting for easily connecting water lines having different diameters.

### BACKGROUND OF THE INVENTION

Water filters are typically placed in line between a water supply and the pipe system of the location (e.g., a home) being supplied with water. Further, suitable bypass valves are also typically desirable for use with water filters so that flow may be directly from the supply to the location pipe system without passing through the filter, for example, during servicing of the water filter.

It is also desirable that the valves provide a suitable flow opening consistent with the pipe size of the location so as to not restrict the flow of water through the pipes. For example, in such installations in which the PVC pipes have a one inch diameter, it is desirable for the bypass valve and the connectors to also have a one inch diameter.

For a variety of reasons, it can in some instances be desirable to direct water to a drain instead of the location pipe system, typically by use of a common flexible hose (e.g., a garden hose) which has a smaller diameter than the pipes of the pipe system. Unfortunately, connection of such hoses to the bypass valve can be difficult. Further, flow through such connections can undesirably generate turbulence or otherwise interfere with desired flow therethrough.

### SUMMARY OF THE INVENTION

In one aspect of the present invention, a fitting is provided for selectively connecting a hose to ports of a water filter bypass valve, each of the ports and the hose being substantially tubular with the hose having an inner diameter less than that of the ports and the ports each having an outer thread therearound. The fitting includes a unitary base member, a second end connector, and first and second washers. The base member includes a first end connector having an inner thread selectively securable to either of the port outer threads, a neck having a hollow interior defined by an inner wall shaped as a truncated cone about a central axis aligned with a central axis of one of the ports when the unitary base member inner thread is secured to the one port outer thread, and a second end having a first outer diameter with a cylindrical opening therethrough open to and coaxial with the neck hollow interior, with the second end cylindrical opening having an inner diameter substantially cylindrical with the hose inner diameter. The unitary base member also includes a disk shaped flange extending outwardly from the second end with a second outer diameter greater than the first outer diameter, and the truncated cone tapers from the port inner diameter adjacent the first end connector to the hose inner diameter adjacent the second end. The second end connector has an inner thread securable to the hose outer thread, with a radially inwardly extending flange disposed around the base member second end, the inwardly extending flange having a third inner diameter greater than the first outer diameter and less than the second outer diameter. The first washer in the first end connector and the second washer is in the second end connector adjacent the base member flange.

In one form of this aspect of the invention, the neck inner wall intersects the central axis at an angle of 15 to 25 degrees.

In another form of this aspect of the invention, an annular shoulder is between the first end connector and the neck of the unitary base member, wherein the first washer is secured in the first end connector adjacent the annular shoulder, and the annular shoulder and the first washer have an inner diameter substantially equal to the port first inner diameter.

In still another form of this aspect of the invention, the first and second washers are rubber, and the first washer has flexible radial projections adapted to extend into the first end connector inner thread to releasably retain the first washer in the first end connector.

In yet another form of this aspect of the invention, the outer surfaces of the first and second end connectors include axially extending ridges.

In another aspect of the present invention, a method of preparing a water filter for use is provided using the above fitting, where the water filter has a first inlet and a second inlet with a bypass valve connected to the first and second inlets with one of the bypass valve ports associated with the first inlet and the other of the bypass valve ports associated with the second inlet. The method includes the steps of (a) connecting the first end connector of the fitting to the bypass valve port associated with the first inlet and connecting the fitting second end connector to the hose, (b) supplying water through the hose to the water filter through the first inlet until water comes out of the bypass valve port associated with the second inlet of the water filter, (c) allowing water to remain in the water filter for a selected period of time, (d) supplying water through the hose to the water filter through the first inlet until water coming out of the bypass valve port associated with the second inlet of the water filter is substantially clear, (e) disconnecting the fitting from the bypass port associated with the first inlet and connecting the first end connector of the fitting to the bypass valve port associated with the second inlet of the water filter, (f) supplying water through the hose to the water filter through the second inlet until water coming out of the bypass valve port associated with the first inlet of the water filter is substantially clear, and (g) removing the fitting from the ports and connecting an incoming water supply source to the bypass valve port associated with the first inlet and connecting a water line to the bypass valve port associated with the second inlet.

Other objects, features, and advantages of the invention will become apparent from a review of the entire specification, including the appended claims and drawings.

### BRIEF DESCRIPTION OF THE DRAWINGS

FIG. 1 is a perspective view of the backwash fitting of the present invention;

FIG. 2 is an exploded view of the FIG. 1 backwash fitting;

FIG. 3 is a side view of the FIG. 1 backwash fitting;

FIG. 4 is a view of the left end of the FIG. 3 backwash fitting;

FIG. 5 is a view of the right end of the FIG. 3 backwash fitting; and

FIG. 6 is an exploded view of the backwash fitting of the present invention as used to connect a hose to the bypass valve of a water filter.

### DETAILED DESCRIPTION OF THE PREFERRED EMBODIMENT

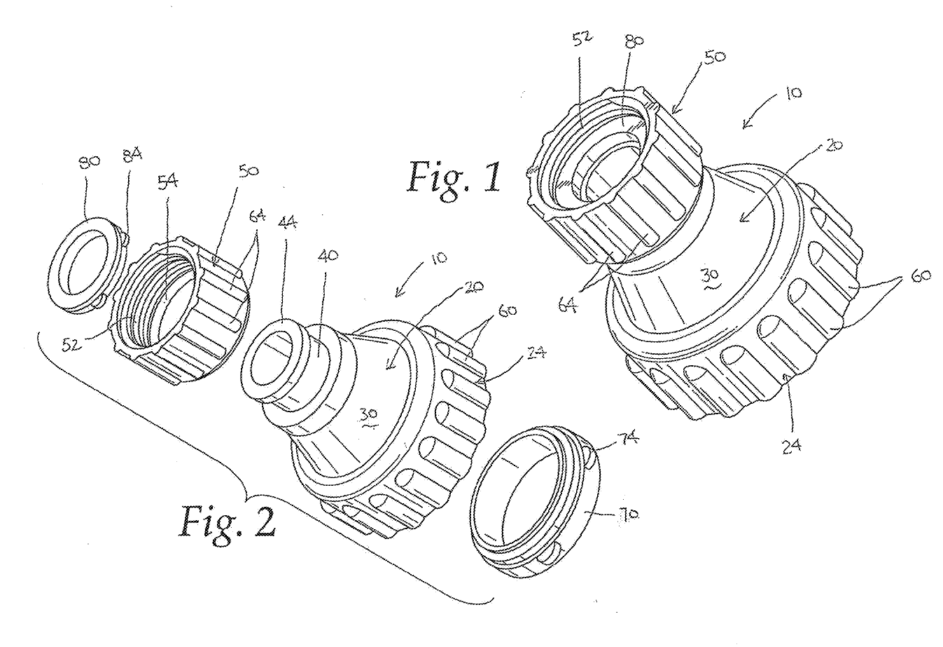

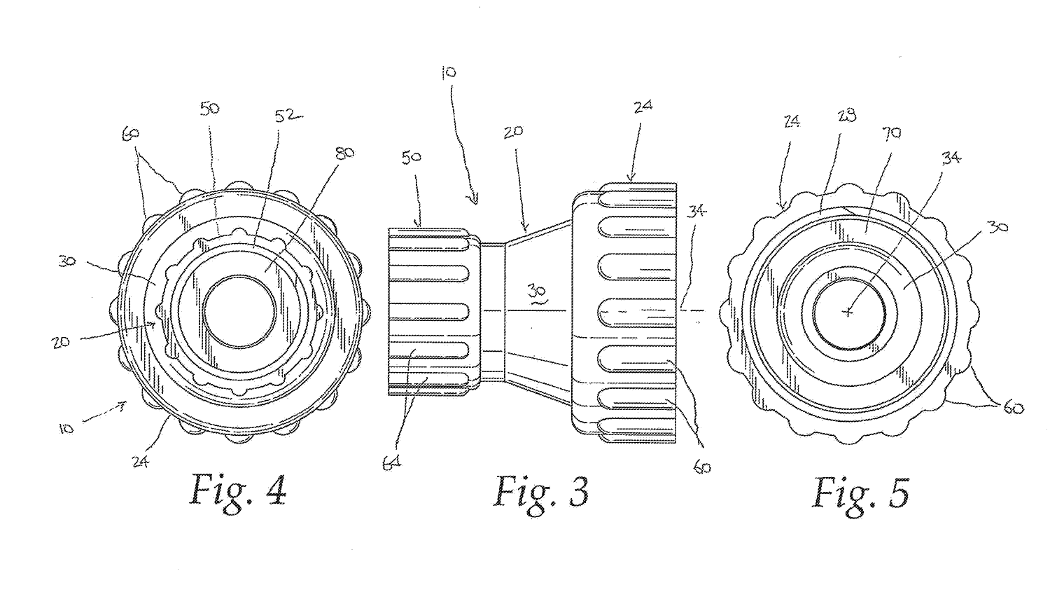

A fitting 10 according to the present invention is illustrated in FIGS. 1-5.

The fitting 10 includes a unitary base member 20 with first and second ends, with a first end connector 24 at the first end having an inner thread 28 (see FIG. 5). A neck 30 has its inner and outer surface in the shape of a truncated cone aligned about a central axis 34, and extends from the first end connector 24 to the base member second end. Advantageously, the inner surface of the neck 30 may be tapered at an angle of 15 to 25 degrees relative to the central axis 34.

The base member second end includes a cylindrical portion 40 having an inner diameter less than the inner diameter of the first end connector 24, whereby the neck 30 tapers down from the first end connector 24 to the second end cylindrical portion 40 as further described below.

A disk shaped flange 44 extends radially outwardly from the second end cylindrical portion 40, and a second end connector 50 having an inner thread 52 is rotatably secured to the second end cylindrical portion 40. Specifically, the second end connector 50 includes an inwardly extending flange 54 having an inner diameter greater than the outer diameter of the second end cylindrical portion 40 and less than the outer diameter of the flange 44, whereby the second end connector flange 54 is trapped on the cylindrical portion 40 by the flange 44 and may be rotated around the cylindrical portion 40.

Advantageously, the first and second end connectors 24, 50, which will be rotated to screw onto a valve port as described in more detail below, may include axially extending ridges 60, 64 on their outer surface to facilitate twisting and tightening when screwing together threaded portions.

A first washer 70 is advantageously located in the first end connector 24, which has an annular shoulder 74 (see FIG. 5) between the first end connector 24 and the neck 30 of the unitary base member 20. The first washer 70 is secured in the first end connector adjacent the annular shoulder 74. For example, the first washer 70 may be made of a suitable elastic material such as rubber, and may advantageously include flexible radial projections 76 adapted to extend into inner thread 28 of the first end connector 24 to releasably retain the first washer 70 therein.

A second washer 80 is advantageously located in the second end connector 50 adjacent the flange 44 of the second end cylindrical portion 40. It too may be made of a suitable elastic material such as rubber, and may advantageously include flexible radial projections 84 adapted to extend into inner thread 52 of the second end connector 50 to releasably retain the second washer 80 therein.

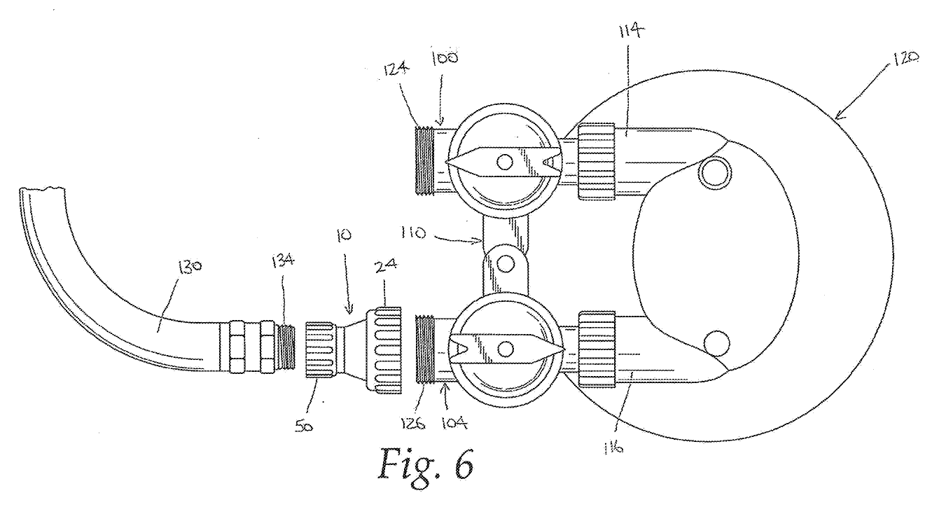

It should be appreciated that, as shown in FIG. 6, the fitting 10 may be selectively securable to either of the ports 100, 104 of a bypass valve 110 secured to the ports 114, 116 of a water filter 120. For example, the fitting 10 may have the inner thread 28 of the first end connector 24 screwed over the outer thread 124, 126 of either of the ports 100, 104, whereby the axis 34 of the fitting 10 will be aligned with the central axis of that port 100 or 104.

Further, the second end of the fitting 10 may be secured to a hose 130 which has an inner diameter less than the inner diameter of the bypass valve ports 100, 104 whereby the taper of the neck 32 facilitates water flow through the change in diameters. It should be appreciated that the normal inner diameter of the water lines connected to the bypass valve 110 would often coincide with the inner diameter of the bypass valve ports 100, 104, but that standard flexible hoses 130 which may be used periodically (as described below) will typically have a lesser diameter than the water lines. The fitting 10 of the present invention facilitates simple connection and disconnection of the hose 130 to both ports 100, 104 notwithstanding this difference. Further, it should be appreciated that the inner diameters of the washers 70, 80 may be made to coincide with the inner diameters of the water flow path at their location so as to provide a smooth flow path with minimal opportunity for impurities to be caught up in crevices outside of the normal flow of water therethrough.

For example, when preparing a water filter 120 for use, the installer may easily connect the first end connector 24 of the fitting 10 to one bypass valve port 104 (e.g., the one associated with an inflow inlet [port 116]) and then connecting the fitting second end connector 50 to the hose 130 by turning the connector 50 to screw its threads 52 onto the outer threads 134 of the hose 130. Water may then be supplied through the hose 130 to the water filter 120 through the inflow inlet (port 116) until water comes out of the bypass valve port 100 associated with the other, downflow inlet (port 114) of the water filter 120.

The supplied water in the filter 120 may then be allowed to remain in the water filter 120 for a selected period of time (e.g., 48 hours), after which water may again be supplied through the hose 130 to the water filter 120 through the inflow inlet (port 116) until the water coming out of the other bypass valve port 100 (e.g., the one associated with the downflow inlet [port 114] of the water filter 120) is substantially clear. At that point, the fitting 10 may be disconnected from the one bypass port 104 and its first end connector 24 may be similarly connected between bypass valve port 100 and hose 130, and then water may be supplied through the hose 130 to the water filter 120 through the downflow inlet (port 114) until water coming out of bypass valve port 104 is substantially clear. When the water is finally clear after those steps, the fitting 10 may be removed from the port 100 and an incoming water supply source and water line (e.g., the inlet of a water line in a dwelling) may be connected to the bypass valve ports 100, 104 to place the water filter 120 in the water line.

It should be appreciated that the present invention may be advantageously used to readily connect and disconnect a hose 130 to and from ports 100, 104 having a larger diameter, to facilitate installation and preparation of water filters in a water line such that this may be easily and readily accomplished by persons without requiring special skills or tools. Moreover, the present invention will allow for these advantages while also providing for desired water flow during such operations.

1. A fitting for selectively connecting a hose to ports of a water filter bypass valve, each of said ports and said hose being substantially tubular with said ports each having an inner diameter and said hose having an inner diameter less than said port inner diameters, said ports and said hose each having an outer thread therearound, said fitting comprising:
a unitary base member including
a first end connector having an inner thread selectively securable to either of said port outer threads,
a neck having a hollow interior defined by an inner wall shaped as a truncated cone about a central axis aligned with a central axis of one of said ports when said unitary base member inner thread is secured to said one port outer thread,
a second end having a first outer diameter with a cylindrical opening therethrough open to and coaxial with said neck hollow interior, said second end cylindrical opening having an inner diameter substantially cylindrical with said hose inner diameter, and
a flange extending outwardly from said second end, said flange being disk shaped with a second outer diameter greater than said first outer diameter,
wherein said truncated cone tapers from said port inner diameter adjacent said first end connector to said hose inner diameter adjacent said second end;
a second end connector having an inner thread securable to said hose outer thread, said second end connector including a radially inwardly extending flange disposed around said base member second end, said inwardly extending flange having a third inner diameter greater than said first outer diameter and less than said second outer diameter;
a first washer in said first end connector; and
a second washer in said second end connector adjacent said base member flange.

2. The fitting of claim 1, wherein the neck inner wall intersects said central axis at an angle of 15 to 25 degrees.

3. The fitting of claim 1, further comprising:
an annular shoulder between said first end connector and said neck of said unitary base member, wherein
said first washer is secured in said first end connector adjacent said annular shoulder, and
said annular shoulder and said first washer have an inner diameter substantially equal to said port first inner diameter.

4. The fitting of claim 3, wherein said first and second washers are rubber, and said first washer has flexible radial projections adapted to extend into said first end connector inner thread to releasably retain said first washer in said first end connector.

5. The fitting of claim 1, wherein the outer surfaces of said first and second end connectors include axially extending ridges.

6. A method of preparing a water filter for use, said water filter having a first inlet and a second inlet with a bypass valve connected to said first and second inlets with one of said bypass valve ports associated with said first inlet and the other of said bypass valve ports associated with said second inlet, comprising the steps of:
connecting the first end connector of the fitting of claim 1 to the bypass valve port associated with the first inlet and connecting the fitting second end connector to the hose;
supplying water through the hose to the water filter through the first inlet until water comes out of the bypass valve port associated with the second inlet of the water filter;
allowing water to remain in the water filter for a selected period of time;
supplying water through the hose to the water filter through the first inlet until water coming out of the bypass valve port associated with the second inlet of the water filter is substantially clear;
disconnecting said fitting from the bypass port associated with the first inlet and connecting the first end connector of the fitting to the bypass valve port associated with the second inlet of the water filter;
supplying water through the hose to the water filter through the second inlet until water coming out of the bypass valve port associated with the first inlet of the water filter is substantially clear; and
removing said fitting from said ports and connecting an incoming water supply source to said bypass valve port associated with said first inlet and connecting a water line to said bypass valve port associated with said second inlet.
